(19) United States
(12) Patent Application Publication
(10) Pub. No.: US 2009/0241752 A1
(43) Pub. Date: Oct. 1, 2009

(54) Capo tasto

(75) Inventor: Georg Vochezer, Argenbuehl-Christazhofen (DE)

Correspondence Address: Lipsitz & McAllister, LLC, 755 MAIN STREET, MONROE, CT, 06468, US

(73) Assignee: Wittner GmbH & Co. KG, Isny (DE)

(21) Appl. No.: 12/386,966

(22) Filed: Apr. 23, 2009

Related U.S. Application Data
(63) Continuation of application No. PCT/EP2007/063025, filed on Nov. 29, 2007.

(30) Foreign Application Priority Data
Dec. 11, 2006 (DE) 10 2006 059 821.0

(51) Int. Cl. G10D 3/00

(52) U.S. Cl. 84/318

(57) ABSTRACT

To provide a capo tasto for fixing on a neck of a stringed musical instrument, comprising a string contact device, a tensioning band for fixing the string contact device on the neck of the stringed musical instrument and a fixing device for fixing the tensioning band on the string contact device, which is universally usable and easy to operate, it is proposed that there be disposed on the string contact device at least one clip, by means of which the capo tasto may be hooked on the neck of the stringed musical instrument.

This application is a continuation of international application number PCT/EP2007/063025 filed on Nov. 29, 2007.

The present disclosure relates to the subject matter disclosed in international application number PCT/EP2007/063025 of Nov. 29, 2007 and German application number 10 2006 059 821.0 of Dec. 11, 2006, which are incorporated herein by reference in their entirety and for all purposes.

### BACKGROUND OF THE INVENTION

The invention relates to a capo tasto for fixing on a neck of a stringed musical instrument, comprising a string contact device, a tensioning band for fixing the string contact device on the neck of the stringed musical instrument and a fixing device for fixing the tensioning band on the string contact device.

Capo tastos are used to shorten the vibrating length of strings of a stringed musical instrument. A capo tasto is clamped around the neck of the stringed musical instrument between two frets and presses the strings onto the frets. The string length between a bridge of the stringed instrument and the fret lying nearest the bridge then remains usable in terms of playing.

From U.S. Pat. No. 3,185,012 a capo tasto is known, which comprises a fixing band.

From U.S. Pat. No. 3,598,012 a capo tasto having a fixing band is likewise known.

From EP 0 979 501 B1 a capo tasto is known, having a frame that comprises an upper arm and a side arm. Fixing is possible by means of a clamping jaw element and a lever element.

### SUMMARY OF THE INVENTION

In accordance with the present invention, a capo tasto is provided, which is universally usable and easy to operate.

In accordance with an embodiment of the invention, there is disposed on the string contact region at least one clip, by means of which the capo tasto is adapted to be hooked on the neck of the stringed musical instrument.

By means of the clip the capo tasto may be fitted prior to the final fixing on the neck of the corresponding stringed musical instrument. A preliminary fixing is therefore achieved. The final clamping by means of the tensioning band may then be carried out by the user with one hand as he no longer has to hold the capo tasto fast. This allows easy and rapid fixing for the user.

Given a corresponding design of the clip, an adaptation to different neck shapes and neck dimensions is possible, with the result that the capo tasto according to the invention is universally usable.

Furthermore, the neck of the stringed musical instrument can be protected from damage by the clip.

In particular, the at least one clip is disposed at a fixed angle to a string contact region of the string contact device. The at least one clip may itself be movable for example owing to intrinsic elasticity. If no force is exerted on the clip, it is then however positioned in a fixed angular position relative to the string contact device. A kind of hook may be formed thereby to allow the capo tasto to be fitted on the neck of the stringed musical instrument.

In particular, the angle lies in a range of between 20° and 50°. In a concrete embodiment, the angle is for example ca. 35°.

It is advantageous if the at least one clip is of such a length that it may be placed onto a part of the periphery of the neck of the stringed instrument region. The part of the periphery lies at the underside of the neck remote from the fingerboard. It may extend over the entire width of the underside or over a part of the width.

It is particularly advantageous if the string contact device comprises a contact pad. The string contact device then presses with this contact pad upon the fingerboard of the stringed musical instrument. The fingerboard is protected from damage.

It is particularly advantageous if the at least one clip is disposed on the contact pad and is for example formed integrally thereon. The contact pad and the clip abut against the neck of the stringed musical instrument. Given suitable formation from a soft material and in particular plastics material, the neck of the stringed musical instrument is protected from damage.

For example, the at least one clip is manufactured from a thermoplastic elastomer. A possible material is TPE.

It is advantageous if the at least one clip owing to intrinsic elasticity of the material, from which it is manufactured, is movable relative to the string contact device. It is thereby possible for example to vary the otherwise fixed angle between the clip and the string contact device. It is therefore possible to fit the capo tasto to necks of musical instruments that are of a different shape and different dimensions. This in turn results in the capo tasto being universally usable.

It is further advantageous if the tensioning band is guided past the at least one clip above the clip once the capo tasto has been fixed on the neck of the stringed musical instrument. This facilitates the fixing because, after the capo tasto has been fitted, the tensioning band may be guided above the clip. There is therefore no need for a threading-in or threading-through of the tensioning band. It is moreover then also possible to exert a force on the clip by means of the tensioning band in order to press the clip against the neck of the stringed musical instrument in order to achieve a better fixing and in particular an all-round bracing of the capo tasto on the neck.

In particular, the at least one clip is then so disposed and designed and the tensioning band is so disposed and designed that by means of the tensioning band the at least one clip may be pressed against the neck of the stringed musical instrument. It is thereby possible to achieve a bracing over a large peripheral region. This in turn also means that force peaks at the neck of the stringed musical instrument can be avoided.

The tensioning band is advantageously mounted by one end in a translationally fixed manner on the string contact device. By virtue of this mounting the structure of the capo tasto is simplified. Furthermore, in this way a rapid fixing facility is achieved.

The tensioning band is advantageously mounted by one end pivotably on the string contact device. An adaptation to different neck shapes and neck dimensions is therefore possible because the angle between the tensioning band in the region of this end and the string contact device is adjustable.

It is advantageous if the at least one clip is disposed on or in the vicinity of an end of the string contact device that lies opposite an end of the string contact device, to which the tensioning band is fixed. This allows the tensioning band to be guided easily over the clip. A high fixing effect is consequently obtained.

It is advantageous if the string contact device comprises a bracket that lies with a first side at least partially over the at least one clip. By means of the bracket a transition region between the string contact device and the clip may be protected. For example, the introduction of excessively high forces into the transition region may be avoided. Furthermore, a guide face for the tensioning band may be provided by means of the bracket.

In particular, the first side of the bow abuts against the at least one clip in order to prevent it for example from being loaded with excessively high forces.

It is quite particularly advantageous if the tensioning band is conveyed on a second side of the bracket that lies opposite the first side. A defined tension band guide is thereby obtained in the fixed state of the capo tasto. This allows a simplified fixing of the capo tasto and for example the prevention of force peaks.

It is advantageous if the tensioning band is fixed to the fixing device. A fixing of the tensioning band on the string contact device may then be achieved by means of the fixing device.

It may be provided that the tensioning band comprises a first region and a second region, which succeed one another in longitudinal direction of the tensioning band, wherein the second region has a smaller width than the first region and the tensioning band is fixed by the second region to the fixing device. It is therefore possible to provide a tensioning band outside the second region with a large width. Forces may therefore be introduced onto the neck of the stringed musical instrument over a larger surface area. As a result of the narrower second region the string contact device and the fixing device may be of a relatively narrow design, thereby allowing the dimensions of the capo tasto and in particular the width to be kept low.

It is advantageous if a fixing region of the tensioning band, by which the tensioning band is fixed to the fixing device, is adjustable. It is thereby possible to achieve an infinite adjustment of the effective length of the tensioning band. This in turn guarantees universal usability.

In one embodiment, the fixing device comprises at least one retaining element for the tensioning band that has an opening, through which the tensioning band is guided. By means of the retaining element the tensioning band may be retained on the fixing device, wherein the effective length of the tensioning band is adjustable depending on the extent to which the tensioning band engages through the opening.

It is advantageous if the string contact device has a receiving space for the fixing device. In the fixed state of the capo tasto, the fixing device may be to a certain extent sunk in the receiving space. Thus, the height dimensions of the capo tasto may be kept low.

It is advantageous if the string contact device comprises at least one retaining recess pair for the fixing device. By means of retaining recesses in the string contact device and in associated counter elements of the fixing device the fixing device may be fixed on the string contact device.

In particular, the retaining recesses of a pair are formed on opposing side walls that bounded a receiving space for the fixing device. The capo tasto is therefore easy to realize.

It is advantageous if a row of spaced-apart retaining recess pairs is provided. In this way, a fixing of the capo tasto on the neck of the stringed musical instrument that is adapted to the neck shape and the neck dimensions may easily be achieved.

In a form of construction of a simple design, the fixing device comprises a shaft stub pair for accommodation by the retaining recesses of a retaining recess pair. The shaft stubs may engage into the retaining recesses. Thus, an introduction is achieved in a simple manner. The fixing device may then be pivoted relative to the string contact device in order to achieve a final fixing and keep the dimensions of the capo tasto low.

It is advantageous if the fixing device has a receiving space for the tensioning band. This allows the external dimensions of the capo tasto to be kept low. Furthermore, a defined tensioning band guide and tension band arrangement is achieved.

In particular, the receiving space is open at least in the direction of one end. Through this end the tension band may be introduced. This in turn allows the tensioning band to be positioned substantially completely in a receiving space of the string contact device.

In particular, the receiving space is bounded by opposing side walls.

It may be provided that one or more retaining elements for the tensioning band are disposed between the opposing side walls. By means of one or more of such retaining elements the side walls may be connected.

It may further be provided that outwardly-directed shaft stubs are disposed on the side walls. The corresponding fixing device may easily be realized.

The following description of preferred forms of construction serves in connection with the drawings to provide a detailed explanation of the invention.

### BRIEF DESCRIPTION OF THE DRAWINGS

FIG. 1 shows a side view of an embodiment of a capo tasto according to the invention;

FIG. 2 shows a view of the capo tasto according to FIG. 1 in direction A;

FIG. 3 shows a sectional view of the capo tasto according to FIGS. 1 and 2 along the line 3-3 according to FIG. 2; and

FIG. 4 shows a plan view of the capo tasto according to FIG. 1 in direction B.

### DETAILED DESCRIPTION OF THE INVENTION

A capo tasto is a device that is used to shorten the vibrating length of strings of a stringed musical instrument such as a guitar, a mandolin or a banjo. A capo tasto is positioned on a neck of the stringed musical instrument between two frets and clamped around the neck. As a result, the strings are pressed onto the frets. The string length that is usable for play is then the length between a bridge of the stringed musical instrument and the one of the two frets that lies nearest the bridge.

Capo tastos are used for example to adapt the corresponding musical instrument to a singing voice. Shortening the strings by means of a capo tasto raises the pitch of the stringed musical instrument; as a result a piece of music no longer has to be transposed into a suitable target key. Capo tastos are used also to convert a piece of music into a form that is technically easier to play without having to change the key, in which it sounds.

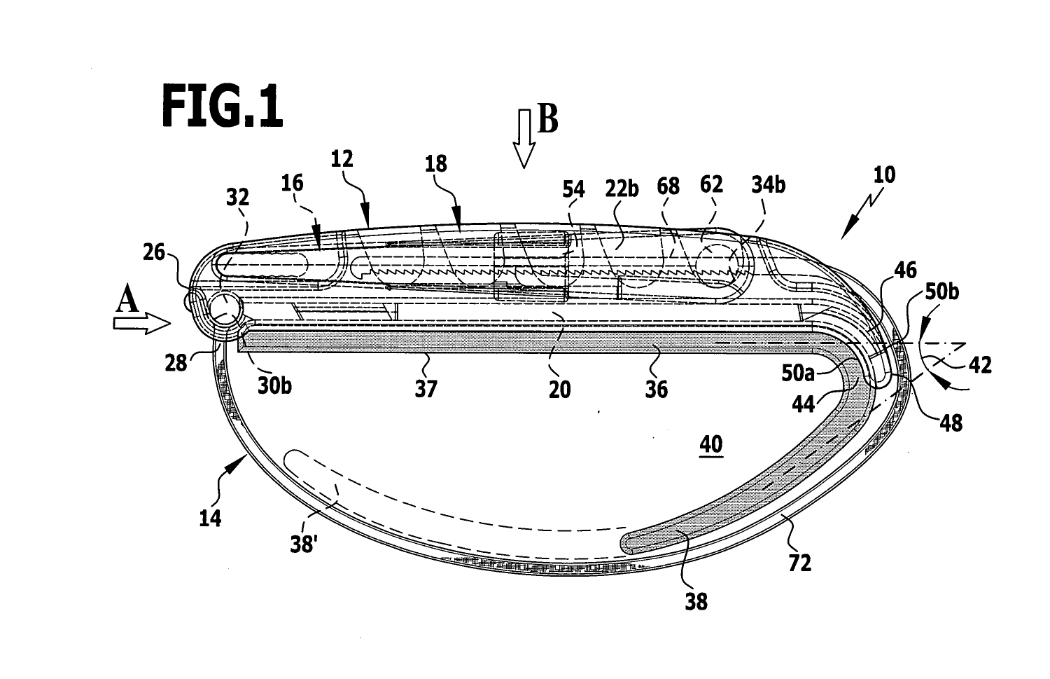

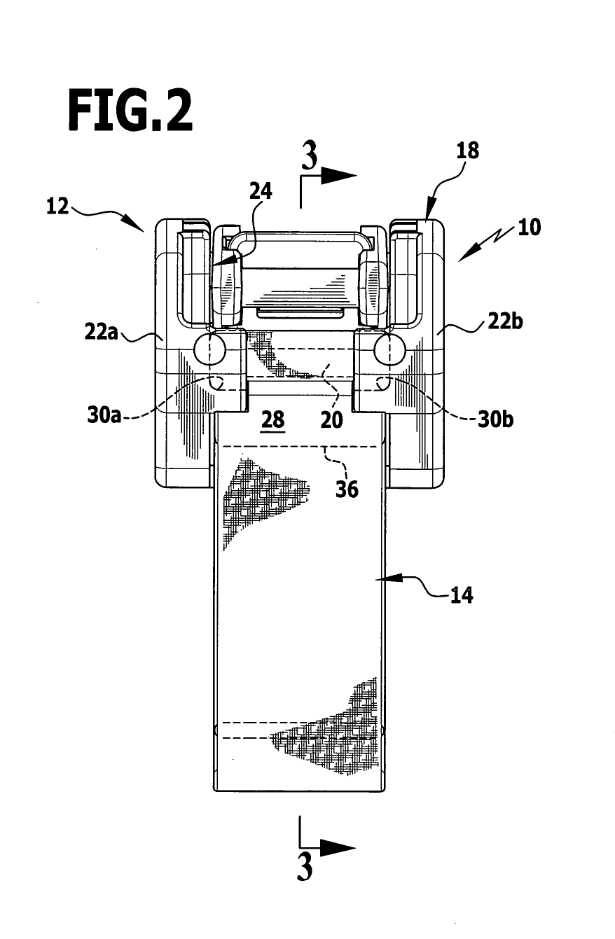

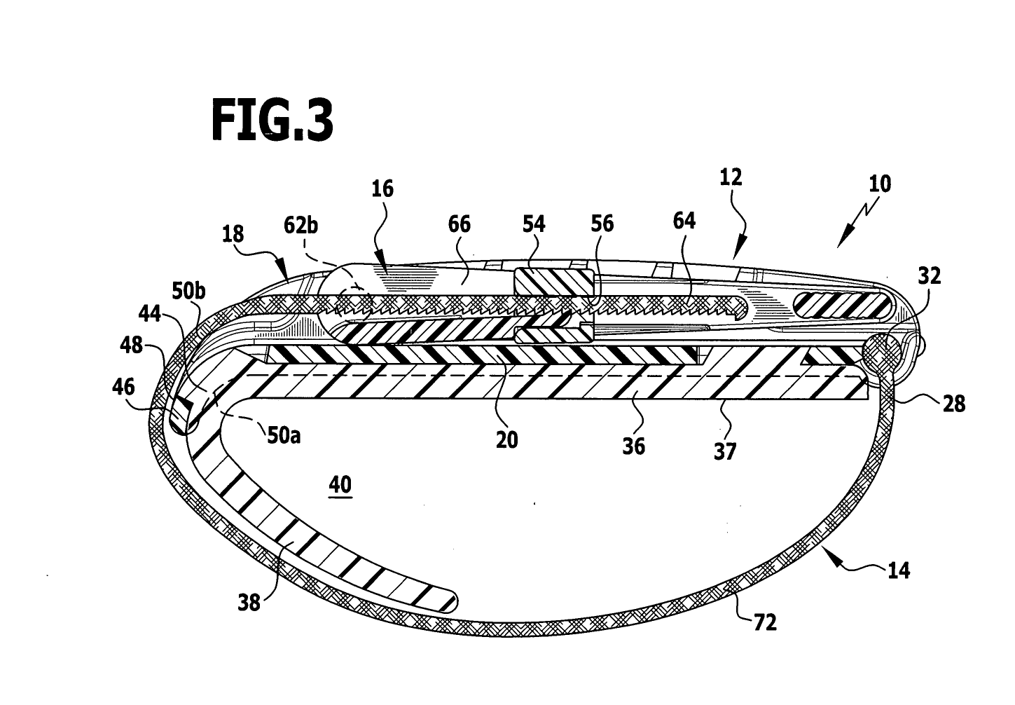

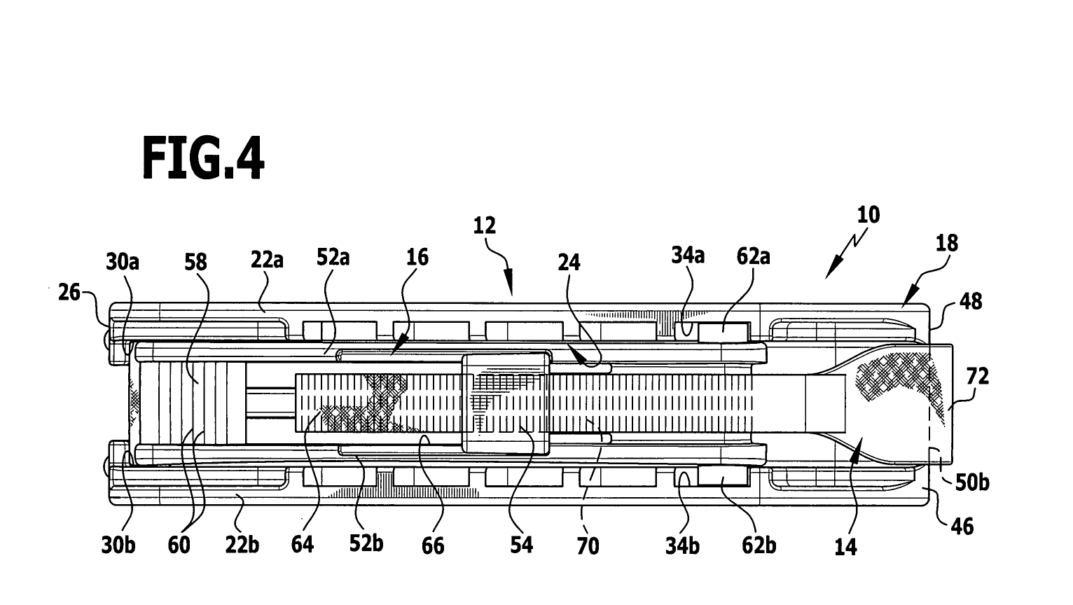

An embodiment of a capo tasto according to the invention that is shown in FIGS. 1 to 4 and denoted there by 10 comprises a string contact device 12, which may act upon the strings of the corresponding stringed musical instrument in order to shorten these strings in terms of play. Fixed on the string contact device is a tensioning band 14, which is used to fix the string contact device 12 on the neck of the corresponding stringed musical instrument and by means of which the capo tasto 10 may be fixed on the stringed musical instrument. The tensioning band 14 is fixed to a fixing device 16, which may in turn be fixed to the string contact device 12.

The string contact device 12 comprises an element 18 that is of a channel-like design. The element 18 has a base 20, on which are seated opposing side walls 22a, 22b. These are formed in particular integrally on the base 20. Between the base 20 and the side walls 22a, 22b a receiving space 24 for the fixing device 16 is formed. Once the capo tasto 10 has been fixed on the neck of the corresponding stringed musical instrument, the fixing device 16 is substantially completely accommodated in this receiving space 24.

The element 18 and hence the string contact device 12 has a first end 26, on which and/or in the vicinity of which a first end 28 of the tensioning band 14 is fixed. On the first end 28 of the tensioning band 14 a pin element 32 is disposed or formed. The pin element 32 is for example a separate element that is fixed on the first end 28 of the tensioning band 14. For example, the tensioning band 14 is guided in a loop around the pin element 32. It is also possible for the pin element 32 to be formed in particular integrally on the tensioning band 14. The pin element 32 is disposed in the recesses 30a, 30b. The recesses 30a, 30b are of a corresponding design for receiving the pin element 32 and are also so designed that the pin element 32 can be introduced into the recesses 30a, 30b and preferably the tensioning band 14 is held captive on the element 18.

The pin element 32 and the recesses 30a, 30b are designed to be adapted to one another in such a way that the tensioning band 14 with the pin element 32 is mounted pivotably and/or rotatably on the string contact device 12 so that the angle, which the tensioning band 14 in the region of its first end 28 assumes relative to the element 18, is variable.

The recesses 30a, 30b represent pivot bearings and/or rotary bearings for the pin element 32.

The element 18 has a plurality of opposing retaining recesses 34a, 34b. The retaining recesses 34a, 34b form a retaining recess pair. In this case, the retaining recess 34a is formed in an inner side of the side wall 22a and the retaining recess 34b in an inner side of the side wall 22b. A plurality of such retaining recess pairs is disposed on the element 18, wherein adjacent retaining recesses in the side wall 22a and/or the side wall 22b are mutually spaced apart. A row of retaining recess pairs is therefore formed. The retaining recesses 34a, 34b are orientated in alignment with one another.

In the embodiment shown in the drawings five retaining recess pairs are provided. As will be described in greater detail below, the retaining recess pairs are used to fix the fixing device 16 to the string contact device 12.

The element 18 is in particular of an integral design and is manufactured from a plastics material.

Fixed on the base 20 of the element 18 is a contact pad 36 that defines a string contact region 37 of the string contact device. The contact pad 36 is used to position the string contact device 12 on the neck of the corresponding stringed musical instrument between the adjacent frets. By means of the contact pad 36 the capo tasto 10 acts upon the strings and presses them onto the frets.

The contact pad 36 is manufactured for example from a thermoplastic elastomer.

Seated on the string contact device 12 is (at least) one clip 38, which is oriented in a downward direction away from the element 18 and inwards at an acute angle. The clip 38 is used to fit the string contact device 12 on the neck of a stringed musical instrument. By means of the clip 38 a kind of hook is formed to allow the string contact device 12 to be fitted on the neck.

It is in particular provided that the clip 38 is connected to the contact pad 36. The connection is for example integral.

The clip 38 may be movable relative to the string contact device 12 and in itself owing to the intrinsic elasticity of the material of the clip 38 in order in particular to achieve a good adaptation to the neck shape. This moreover allows the string contact device 12 to be held clamped by means of the clip 38 on the neck of a stringed musical instrument. As a result of the intrinsic elasticity of the clip 38 an intermediate space 40 between the clip 38 and the contact pad 36 may be enlarged to allow an adaptation to different neck shapes and neck sizes.

The clip 38 is seated at an angle 42 to the contact pad 36, wherein the contact pad 36 defines the string contact region 37 of the string contact device 12 (FIG. 1). This angle 42 is a fixed angle when no force is exerted on the clip 38. It lies in particular in the range of between ca. 20° and 50°. In a concrete embodiment this angle is ca. 35°.

The clip 38 is of such a length that a fitting hook is formed and the clip 38 may be placed onto a part of the neck of the stringed musical instrument outside of the frets. The length of the clip 38 in the illustrated embodiment is smaller than the length of the contact pad 36. For example, the length of the clip 38 is less than half the length of the contact pad 36.

It is also possible for the clip 38 to be more than half the length of the contact pad 36 and be for example of such a design that it may be placed onto the neck over the entire width of an underside thereof. A corresponding clip is indicated by dashed lines and denoted by 38′ in FIG. 1.

The contact pad and the clip 38 are connected to one another by a transition region 44. In the transition region 44 the contact pad 36 and the clip 38 are of a curved design to allow the transition.

The element 18 comprises a bracket 46, which is disposed on or in the vicinity of a second end 48 of the string contact device 12. The bracket 46 is in particular integrally formed on the element 18. The bracket 46 at least partially overlaps the transition region 44. It abuts with a first side 50a against the transition region 44 and hence protects the transition region 44. On an opposite second side 50b the tensioning band 14 is guided.

The fixing device 16 comprises a first side wall 52a and a second side wall 52b, which are spaced apart opposite one another. The first side wall 52a and the second side wall 52b are connected to one another by a retaining element 54. This retaining element 54 has a through-opening 56, through which the tensioning band 14 is guided.

The first side wall 52a and the second side wall 52b may be connected by one or more further web elements 58. For example, on or in the vicinity of one end of the fixing device 16 a web element 58 is provided. This web element 58 is provided at an upper side with ribbing 60. A user may press the fixing device 16 by means of the ribbing 60 down towards the string contact device 12.

The fixing device 16 comprises a shaft stub pair having a first shaft stub 62a and a second shaft stub 62b. These shaft stubs may be accommodated by the corresponding retaining recesses 34a, 34b. Through the selection of the respective retaining recess pair the free length of the tensioning band 14 between the first end 26 and the bracket 46 is determined.

The tensioning band 14 is threaded through the opening 56 of the retaining element 54. A second end 64 of the tensioning band 14 lies between the side walls 52a, 52b of the fixing device 16, which form a receiving space 66 for the tensioning band 14. The second end 64 is directed towards the web element 58.

By means of the position of the second end 64 of the tensioning band 14 relative to the retaining element 54 the length of the tensioning band 14 between the retaining element 54 and the first end 26 is continuously adjustable. The retaining element 54 with its opening 56 is designed to be adapted to the tensioning band 14 in such a way that the tensioning band 14 may be fixed for example, in force-locking manner on the retaining element 54. For this purpose, it may be provided that the tensioning band 14 in a corresponding second region 68 is roughened and in particular provided with ribbing 70 in order to allow a force-locking fixing on the retaining element 54 and hence on the fixing device 16.

The tensioning band 14 also comprises a first region 72, wherein the first region 72 and the second region 68 succeed one another in longitudinal direction of the tensioning band 14. By means of the first region 72 the capo tasto 10 is clamped on the neck of a stringed musical instrument. The first region 72 has a larger width than the second region 68. By means of the second region 68 the tensioning band 14 is guided in the receiving space 66 of the fixing device 16 and fixed by means of a fixing region of the second region 68 on the fixing device 16 (namely on the retaining element 54).

The tensioning band 14 is fixed by a fixing region to the retaining element 54 and hence on the fixing device 16. The fixing region is variable depending on the extent, to which the tensioning band 14 engages through the opening 56.

The receiving space 66 is open-ended at an end that lies opposite the end on which the web element 58 is disposed, thereby allowing the tensioning band 14 to engage with its second region 68 into the receiving space 66.

The tensioning band 14 with its first region 72 and its second region 68 may be of an integral design. It is alternatively possible for the first region 72 and the second region 68 to be manufactured separately and subsequently fixed on one another.

The first region 72 of the tensioning band 14 is guided on the second side 50b of the bracket 46 once the capo tasto has been fixed on the neck of a stringed musical instrument.

The tensioning band 14 lies above the clip 38. During tensioning of the tensioning band 14, the tensioning band 14 may press against the clip 38 and hence press the clip 38 towards the neck of the stringed musical instrument. The capo tasto 10 according to the invention operates as follows:

To fix the capo tasto 10 on a stringed musical instrument the fixing device 16 is released from the string contact device 12. The shaft stubs 62a and 62b are disengaged from the retaining recesses 34a, 34b and the fixing device 16 is positioned outside of the receiving space 24 of the string contact device 12. The tensioning band 14 has to a certain extent a loose end. It is fixed by means of the first end 26 on the string contact device 12. In this state, this fixing is the sole fixing of the tensioning band 14 on the capo tasto 10.

By means of the position of the second end 64 of the tensioning band 14 relative to the retaining element 54 a user may continuously adjust the required tensioning band length by way of adaptation to the specific stringed musical instrument.

The user fits the capo tasto 10 in the desired position on the neck of the stringed musical instrument by means of the clip 38. Given a corresponding design of the clip 38, the capo tasto 10 is retained through clamping. A kind of preliminary fixing is therefore effected.

A user may then with one hand guide the tensioning band 14 with the fixing device 16 round the neck and in this case also round the clip 38. The shaft stubs 62a, 62b of the fixing device 16 are inserted into the corresponding retaining recesses 34a, 34b. During insertion the fixing device 16 is oriented transversely of the string contact device 12. For example, the fixing device 16 is oriented with its side walls 52a, 52b at an angle of 90°+/−45° relative to the element 18.

Once the shaft stubs 62a, 62b have been introduced, a user may pivot the fixing device 16 towards the string contact device 12, i.e. pivot it in a downward direction in order to move the fixing device 16 into the receiving space 24. In this case, once the shaft stubs 62a, 62b have been inserted into the retaining recesses of the appropriate retaining recess pair, the tensioning band 14 is finally tensioned. It presses against the neck in the region outside of the clip 38. In the region of the clip 38 it presses the clip against the neck. The contact pad 36 is moreover pressed against the appropriate frets. Once the fixing device 16 has been positioned in the receiving space 24, the corresponding position of the capo tasto 10 is then fixed.

The clip 38 allows one-handed control of the clamping of the capo tasto 10 onto the neck of the stringed musical instrument. By means of the clip 38, given a corresponding intrinsically elastic design, an adaptation to different neck shapes and neck dimensions is possible, with the result that the capo tasto 10 is universally usable.

By virtue of the continuous adjustability of the tensioning band length by means of the retaining element 54 and by virtue of the adjustment of the position of the fixing device 16 on the string contact device 12 by means of the retaining recess pairs, an adaptation to different neck shapes and neck dimensions is likewise possible in order to realize universal usability.

Given a corresponding formation of the contact pad 36 and the clip 38 by means of a non-rigid plastics material such as TPE, the stringed musical instrument is effectively protected from damage.

1. Capo tasto for fixing on a neck of a stringed musical instrument, comprising:
a string contact device;
a tensioning band for fixing the string contact device on the neck of the stringed musical instrument; and
a fixing device for fixing the tensioning band on the string contact device;
wherein disposed on the string contact device is at least one clip, by means of which the capo tasto is adapted to be hooked on the neck of the stringed musical instrument.

2. Capo tasto according to claim 1, wherein the at least one clip is disposed at a fixed angle relative to a string contact region of the string contact device.

3. Capo tasto according to claim 2, wherein the angle lies in a range of between 20° and 50°.

4. Capo tasto according to claim 1, wherein the at least one clip is of such a length that it may be placed onto a part of the periphery of the neck of the stringed musical instrument.

5. Capo tasto according to claim 1, wherein the string contact device comprises a contact pad.

6. Capo tasto according to claim 5, wherein the at least one clip is disposed on the contact pad.

7. Capo tasto according to claim 5, wherein the at least one clip is formed integrally on the contact pad.

8. Capo tasto according to claim 1, wherein the at least one clip is manufactured from a thermoplastic elastomer.

9. Capo tasto according to claim 1, wherein the at least one clip owing to intrinsic elasticity of the material, from which it is manufactured, is movable relative to the string contact device.

10. Capo tasto according to claim 1, wherein the tensioning band is guided past the at least one clip above the clip once the capo tasto has been fixed on the neck of the stringed musical instrument.

11. Capo tasto according to claim 10, wherein the at least one clip is so disposed and designed and the tensioning band is so disposed and designed that the at least one clip can be pressed against the neck of the stringed musical instrument by means of the tensioning band.

12. Capo tasto according to claim 1, wherein the tensioning band is mounted by one end in a translationally fixed manner on the string contact device.

13. Capo tasto according to claim 1, wherein the tensioning band is mounted by one end pivotably on the string contact device.

14. Capo tasto according to claim 1, wherein the at least one clip is disposed on or in the vicinity of an end of the string contact device that lies opposite an end of the string contact device, to which the tensioning band is fixed.

15. Capo tasto according to claim 1, wherein the string contact device comprises a bracket, which lies with a first side at least partially over the at least one clip.

16. Capo tasto according to claim 15, wherein the first side of the bracket abuts against the at least one clip.

17. Capo tasto according to claim 15, wherein the tensioning band is guided on a second side of the bracket that lies opposite the first side.

18. Capo tasto according to claim 1, wherein the tensioning band is fixed to the fixing device.

19. Capo tasto according to claim 1, wherein the tensioning band comprises a first region and a second region, which succeed one another in longitudinal direction of the tensioning band, wherein the second region has a smaller width than the first region and the tensioning band is fixed by the second region to the fixing device.

20. Capo tasto according to claim 18, wherein a fixing region of the tensioning band, by which the tensioning band is fixed on the fixing device, is adjustable.

21. Capo tasto according to claim 1, wherein the fixing device comprises at least one retaining element for the tensioning band that has an opening, through which the tensioning band is guided.

22. Capo tasto according to claim 1, wherein the string contact device has a receiving space for the fixing device.

23. Capo tasto according to claim 1, wherein the string contact device comprises at least one retaining recess pair for the fixing device.

24. Capo tasto according to claim 23, wherein the retaining recesses are formed in opposing side walls that form a receiving space for the fixing device.

25. Capo tasto according to claim 23, characterized by a row of spaced-apart retaining recess pairs.

26. Capo tasto according to claim 23 wherein the fixing device comprises a shaft stub pair for accommodation by means of the retaining recess of a retaining recess pair.

27. Capo tasto according to claim 1, wherein the fixing device has a receiving space for the tensioning band.

28. Capo tasto according to claim 27, wherein the receiving space is open at least in the direction of one end.

29. Capo tasto according to claim 27, wherein the receiving space is bounded by opposing side walls.

30. Capo tasto according to claim 29, wherein one or more retaining elements for the tensioning band are disposed between the opposing side walls.

31. Capo tasto according to claim 27, wherein outwardly-directed shaft stubs are disposed on the side walls.
